(19) United States
(12) Patent Application Publication
(10) Pub. No.: US 2024/0031024 A1
(43) Pub. Date: Jan. 25, 2024

(54) Determining Gains for Amplifiers in an Optical Network

(71) Applicant: Telefonaktiebolaget LM Ericsson (publ), Stockholm (SE)

(72) Inventors: Roberto Magri, Genova (IT); Riccardo Ceccatelli, Genova (IT)

(21) Appl. No.: 18/030,194

(22) PCT Filed: Oct. 7, 2020
(86) PCT No.: PCT/EP2020/078138

§ 371 Date: Apr. 4, 2023

(51) Int. Cl. H04B 10/079

(52) U.S. Cl. CPC H04B 10/07955

(57) ABSTRACT

In a first aspect, a method performed by a management node for an optical network is provided. The optical network comprising a plurality of receivers and a plurality of amplifiers. The method comprises measurements of received power for the signals received at the receivers and target received power values for the receivers. The method further comprises inputting the received power measurements and target received power values into an optimisation process to determine gain values to be applied by the amplifiers on signals sent to the receivers. The method further comprises outputting the gain values for implementation at the amplifiers.

### TECHNICAL FIELD

Embodiments of the present disclosure relate to optical networks, and in particular to methods and apparatus for determining gain values to be applied by amplifiers in an optical network.

### BACKGROUND

Amplifiers in optical networks, such as Erbium Doped Fibre Amplifiers (EDFAs), can operate in a constant gain mode, in which a predetermined gain is applied to an input signal regardless of the power of an input signal, or a constant power mode, in which signals are output from the amplifier at a predetermined power. In dense wavelength division multiplexing (DWDM) networks, operating in a constant power mode may be preferred as it provides direct control of the power profile of each wavelength. However, in order to make full use of this control scheme real-time monitoring may be required of the number of channels input to the amplifier, necessitating the use of a reliable method for counting wavelengths. This may be achieved by using a monitoring element such as an optical channel monitor (OCM) or a wavelength selective switching (WSS) module at each amplifier in the network, for example.

In contrast, amplifiers operating in a constant gain mode are typically configured to apply a gain that is equal to the span loss on the span preceding the amplifier. The gain of the amplifier may thus be set such that the signal losses that occurred between a preceding amplifier and the present amplifier (which may include any signal losses due to passive components on the link) are compensated for. Constant gain mode therefore does not require knowledge of the number of channels that are input to the amplifier, which means it is suitable for networks in which amplifiers are not supplied with channel monitoring elements such as, for example, OCM or WSS modules.

For this and other reasons, constant gain mode is often used in segments of optical metro networks, as well as in internet protocol (IP) over wavelength division multiplexing (WDM; IPoWDM) networks. Constant gain mode may particularly be used in parts of networks that are used for network access or aggregation. In these examples, amplification is often needed to recover span losses, as well as losses occurring at fixed optical add/drop multiplexer (FOADM) filters or splitters, but the presence of channel monitoring elements (such an OCM or WSS modules) at each amplifier cannot be guaranteed.

However, operating an amplifier in constant gain mode requires appropriately setting the gain applied by the amplifier such that any amplified signals are received at a subsequent node with a received power and at an optical signal-to-noise ratio (OSNR) that are within the receiving node's operating ranges. Moreover, as optical networks often contain large numbers of amplifiers, small errors in the gain settings of individual amplifiers can aggregate to cause the received power of a channel to fall outside of the operating ranges of downstream nodes, which increases the risk that data sent over the network may be lost or corrupted.

To mitigate this risk, the gain applied by an amplifier in an optical network may be determined by measuring the loss that occurs on the span preceding the amplifier (the span loss) and setting the gain accordingly to compensate for that loss.

One method for measuring span loss involves using power monitor photodiodes at the transmitter side and receiver side of amplifiers in the network. The difference between the total optical power transmitted at an output of an amplifier and the power received by the next amplifier is a measure of the total losses encountered by the optical signal on the link, thus providing a measure of span loss. However, this method relies on measurements of the total optical power, rather than, for example, the power per channel, which means it can provide misleading span loss measurements when a channel is added or dropped (e.g. by an FOADM) on the link.

Another approach involves using measurements of the transmitted and received power of a dedicated Optical Supervisory Channel (OSC) to estimate span loss. Some networks are provided with an OSC to support the connection of network nodes to a Data Control Network (DCN), for example. The OSC may be inserted after an amplifier and extracted before a subsequent amplifier (e.g. using filters). In this way, the span loss can be measured by determining the difference between the transmitted power of the OSC at a first amplifier and a received power of the OSC at a second, subsequent amplifier.

In contrast to the first approach outlined above, an OSC provides a measurement of actual span loss (e.g. for a specific channel), as it is based on the specific wavelength of the OSC, rather than the total signal power on the link. However, the span loss measurements obtained using an OSC may be less precise than those obtained using power monitor photodiodes. An OSC is usually implemented using 1 Gigabit Ethernet (GE) or 10 GE transceivers, for which transmitter and receiver power can typically be measured to an accuracy of ±2 dB, meaning that any span loss estimates may be subject to an error of around ±4 dB. This can be particularly problematic in a chain of amplifiers, as the error in the span loss at each amplifier contributes to the overall error for each channel.

Another approach is to manually measure span losses when the network is first implemented. In this approach, an operator measures the loss of each span using appropriate instruments (such as, for example, a portable laser source and a power meter) and configures the gain applied by each amplifier accordingly. The configured gains may be manually adjusted later when, for example, a network node is repaired or removed. Whilst this approach may provide more accurate span loss measurements (and thus gain values) when the network is first set up, it does not account for span ageing or any other variations in the network during its lifetime. In addition, this approach requires manual intervention by an operator, which increases operation costs and requires skilled in-field personnel.

### SUMMARY

Embodiments of the present disclosure seek to address these and other problems.

In one aspect, a method performed by a management node for an optical network is provided. The optical network comprises a plurality of receivers and a plurality of amplifiers. According to this method, the management node obtains measurements of received power for the signals received at the receivers. The management node also obtains target received power values for the receivers, and inputs received power measurements and target received power values into an optimisation process to determine gain values to be applied by the amplifiers on signals sent to the receivers. The gain values are output by the management node for implementation at the amplifiers.

In a further aspect, the disclosure provides an apparatus to perform the method recited above. A further aspect provides a computer program for performing the method recited above. A computer program product, comprising the computer program, is also provided.

A still further aspect of the present disclosure provides an apparatus comprising a processor and a machine-readable medium. The apparatus is operable to implement a management node in an optical network, in which the optical network comprises a plurality of amplifiers and a plurality of receivers. The machine-readable medium contains instructions executable by the processor such that the apparatus is operable to measurements of received power for the signals received at the receivers. The apparatus is further operable to obtain target received power values for the receivers, and input the received power measurements and target received power values into an optimisation process to determine gain values to be applied by the amplifiers on signals sent to the receivers. The apparatus is further operable to output the gain values for implementation at the amplifiers.

Embodiments of the disclosure set out herein may enable the optimization of an amplified DWDM network operating in Constant Gain mode, by properly setting the gain of any amplification stage, without the presence of additional channel monitoring modules like OCM or WSS. In this way, limitations as to the accuracy of total power monitoring and span loss measurement are overcome. Based only on the received power of traffic, embodiments of the disclosure converge rapidly to the expected operating point for the whole system.

### BRIEF DESCRIPTION OF THE DRAWINGS

For a better understanding of examples of the present disclosure, and to show more clearly how the examples may be carried into effect, reference will now be made, by way of example only, to the following drawings in which:

FIG. 1 is a schematic diagram of an optical network according to embodiments of the disclosure;

FIG. 2 is a flowchart of a method performed by a management node according to embodiments of the disclosure;

FIG. 3 is a schematic diagram of an optical network according to embodiments of the disclosure;

FIG. 4 is a schematic diagram of an optical network according to embodiments of the disclosure;

FIG. 5 shows received power measurements and optical signal-to noise ratio measurements for receivers in a simulation of an optical network;

FIGS. 6a and 6b show received power measurements and signal-to-noise ratio measurements for receivers in a simulation of an optical network;

FIG. 7 is a flowchart of a method performed by a management node according to embodiments of the disclosure; and

FIGS. 8 and 9 are schematic diagrams of apparatuses according to embodiments of the disclosure.

### DETAILED DESCRIPTION

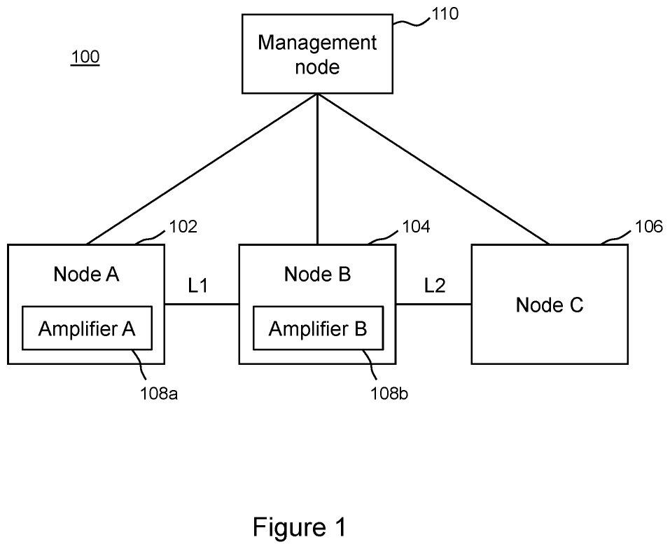

FIG. 1 shows an optical network 100 according to embodiments of the disclosure. The optical network 100 may implement Wavelength Division Multiplexing (WDM) and in particular may be a Dense WDM (DWDM) network. Signals of different wavelengths may thus be multiplexed over one or more links in the network 100, enabling transmission of multiple channels.

The optical network 100 comprises a plurality of nodes 102, which are labelled Node A 102, Node B 104 and Node C 106. The nodes 102-106 are configured to transmit and/or receive optical signals in the network 100. Nodes A and B 102, 104 are connected by optical link (or span) L1, and Nodes B and C 104, 106 are connected by optical link (or span) L2 for sending signals between the respective nodes. The links L1, L2 may be one-way such that, for example, signals can be transmitted from Node A 102 to Node B 104, but not from Node B 104 to Node A 102, or the links L1, L2 may be bi-directional such that signals can be transmitted in either direction. Although three nodes are shown, the skilled person will appreciate that the network 100 may comprise one or more additional nodes. The additional nodes(s) may or may not comprise an optical amplifier, and may or may not be connected to the management node 110. For example, an additional node may be a passive or active optical node. Similarly, the network 100 may comprise more links than illustrated, e.g. be arranged in a mesh or tree structure. For example, Node C 106 may be configured to send signals to one or more other nodes in the network (not illustrated).

The nodes 102-106 may be any type or combination of network nodes. For example, one or more of the network nodes 102-106 may comprise one or more of a multiplexer, a demultiplexer, an optical add filter, an optical drop filter and an in-line amplifier (ILA). One or more of the network nodes 102-106 may thus comprise, for example, an optical add-drop multiplexer such a Fixed Optical Add-Drop Multiplexer (FOADM) or a Reconfigurable Optical Add-Drop Multiplexer (ROADM).

As illustrated, Node A 102 and Node B 104 comprise at least one amplifier each, labelled Amplifier A 108a and Amplifier B 108b. The skilled person will appreciate that Node C 106 (or an additional node) may, in some examples, also comprise one or more amplifiers, but they are not shown here for simplicity.

The amplifiers 108 may comprise any suitable amplifiers such as, for example, one or more doped fibre amplifiers (e.g. Erbium Doped Fibre Amplifiers, EDFAs), solid-state amplifiers or semiconductor optical amplifiers. The skilled person will appreciate that amplifiers in a network can serve a variety of purposes. For example, one or more of the amplifiers may act as a preamplifier (PA) for amplifying a signal before it is processed by a node, a booster amplifier (BA) for amplifying a signal for transmission or a single stage amplifier (SSA) for amplifying a signal transmitted on a span or link.

Thus, for example Node A 102 may be an FOADM node comprising an optical add-drop multiplexer (OADM) accommodated between a preamplifier that amplifies signals that are input to the OADM and a booster amplifier that amplifies signals that are output from the OADM. In another example, Node B 104 may be an ILA comprising a single stage amplifier in each direction. Node B 104 may thus comprise a first SSA for amplifying signals received from Node A 102 to be transmitted to Node C 106 and a second SSA for amplifying signals received from Node C 106 to be transmitted to Node A 102.

The amplifiers 108a and 108b (108 collectively) apply gain to signals transmitted by Node A 102 and Node B 104 over links L1 and L2 respectively. The amplifiers 108 operate in constant gain mode, which means that an amplifier applies a same gain value to each input signal, regardless of its power.

The gain applied by each amplifier may be set to an estimate of the power loss on the span preceding the amplifier (span loss) to compensate for signal losses. As described above, there are various methods for determining span loss, including installing power monitor photodiodes at transmitters and receivers in the network, using an OSC channel and manually measuring span loss using a portable laser source and a power meter.

However, each of these approaches has its limitations. For example, the photodiodes may only provide measurements of the total span loss, rather than the span loss per channel. Span loss estimates for specific wavelengths (or channels) can be determined using an OSC, but this can come at a detriment to precision. Finally, manually measuring span losses requires skilled in-field personnel, and can make it difficult to update span loss estimates when there are changes in the network.

Therefore, although span loss measurements can be used to determine gains applied by amplifiers in a network, existing approaches for obtaining these measurements have their limitations. Moreover, poor gain settings in an optical network can risk loss or corruption of data transmitted over the network. In particular, if a gain applied by an amplifier on a signal is inadvertently set too high, there is a risk that a node receiving the signal will be overloaded, as the signal may exceed an upper received power threshold for the receiving node. However, there is also a risk that applying too small a gain to a signal may mean that the signal power is below the receiver's sensitivity (e.g. it is received at a power that is too low for the receiver to detect or process). In the latter case, there is also a risk that the received signal may be too noisy for data to be meaningfully extracted from the signal.

Aspects of the disclosure seek to address these and other problems.

In one aspect, an optimisation process is used to determine gain values to be applied by a plurality of amplifiers in the network. Rather than determining the gain values to be applied by each amplifier separately, an optimisation process is used to jointly determine gain values for the plurality of amplifiers. Received power measurements for the receivers, and target received power values for the receivers are input to the optimisation process to determine gain values that are output for implementation at corresponding amplifiers. The gain values are applied to amplifiers operating in a constant gain.

Accordingly, the network 100 further comprises a management node 110. The management node 110 is in communication with the nodes 102-106 in the network, and is operable to control the gain values applied by one or more of the amplifiers 108. For example, the management node 110 may be operable to obtain initial gain values applied by the amplifiers 108 on signals sent to Node B and Node C 104, 106 and is operable to receive corresponding measurements of received signal power for the signals received at Node B and Node C 104, 106 (e.g. from Node B 104 and Node C 106). The management node 110 is further operable to obtain target received power values for Node B and Node C 104, 106. Each node may be associated with a single target received power value or more than one received power value (e.g. a node may be associated with a target received power value per channel). However, rather than simply indicating the operating ranges of the nodes (e.g. indicating the sensitivity and saturation points of the nodes), the received power values indicate a specific power at which it is preferred for a given node to receive a signal. In one embodiment, the received power values correspond to expected average operating powers for the nodes.

The management node 110 is operable to input the received power measurements and target received power values into an optimization process to determine updates to the gain values to be applied by the amplifiers 108. The optimization process is configured to optimize the gain value for a plurality of amplifiers in a single optimization process. For example, a single optimization is based on the gain of all the amplifiers in a chain of nodes. The optimization process may be used to, for example, determine gain values that minimise a difference between signal power measured at the receivers (received power measurements) and the target received power values. The management node 110 outputs the determined gain values to Node A 102 and Node B 104 to be applied by their respective amplifiers 108a, 108b.

By using input data for multiple amplifiers and receivers as input to the optimisation process, the gain values for a given amplifier in the network 100 may be jointly determined with the gain values for other amplifiers in the network 100, which means that the gain values can be optimised across the network 100 in a single step. As noted above, the received signal power at a downstream node is dependent upon the gain values applied by upstream nodes. Thus, in the illustrated example, the received signal power measured at Node C 106 depends on the gains applied by the amplifiers 108 at Nodes A and B 102, 104. By jointly determining the gains to be applied by the amplifiers 108 at Nodes A and B 102, 104, whilst also taking into account the target received powers for Nodes B and C 104, 106, aspects of the present disclosure provide a method by which the gains applied by amplifiers in a network can be optimised to minimise the risk of data loss or corruption.

In particular examples, the management node 110 may be an optical link controller (OLC). In some examples, the OLC is a Software Defined Network (SDN) controller. The management node 110 may thus, for example, be connected to the network nodes 102-106 via a Data Control Network (DCN). The embodiments disclosed herein may thus be implemented using existing network nodes, thereby tuning the gain values applied by amplifiers in the network without requiring additional network infrastructure such as an OSC.

The skilled person will appreciate that the process described above may be applied iteratively, so that the optimisation process is repeated until, for example, received power measurements converge to the target received power values. In particular examples, the process may be repeated at intervals or when there is a change in the network 100 (e.g. a new node is added). In this way, gains applied by amplifiers 108 in the network 100 can be adapted over time to account for variations in the network 100, thereby reducing the risk of, for example, a node in the network 100 receiving a signal with a power below its sensitivity, or alternatively, a signal that exceeds its upper received power limit (e.g. the risk of a node being overloaded). This, in turn, reduces the risk of data loss or corruption in optical networks.

Aspects of the present disclosure thus provide methods for optimising gains to be applied by amplifiers in an optical network, thereby reducing the risk of data loss or data corruption in the network.

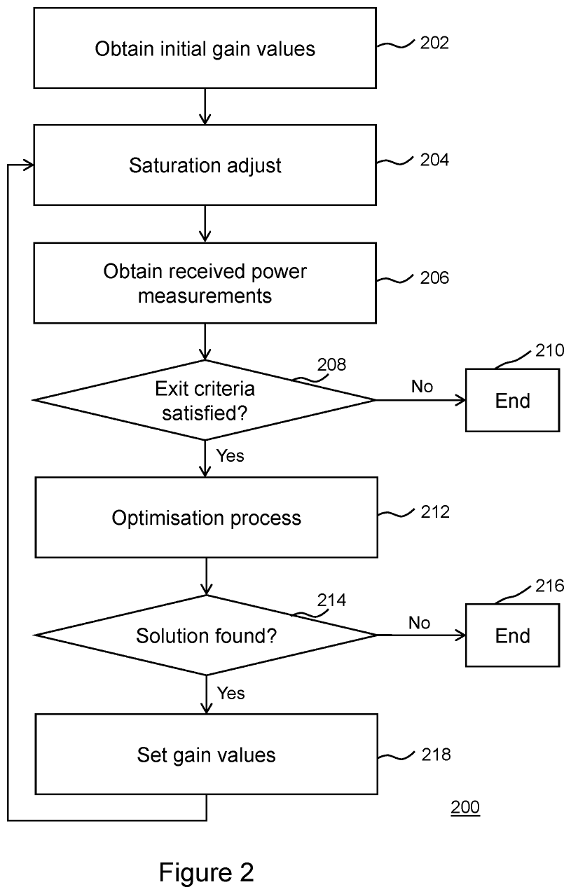

FIG. 2 shows a method 200 performed by a management node in an optical network according to embodiments of the disclosure. The optical network may, for example, be the optical network 100 described above with respect to FIG. 1. The management node may be the management node 110 described in respect of FIG. 1, for example. The management node 110 may thus be an OLC, for example.

The network 100 comprises a plurality of amplifiers and a plurality of receivers. The amplifiers may be the amplifiers 108 described above with respect of FIG. 1, for example. Thus, one or more of the amplifiers may function as for example, an in-line amplifier, a booster amplifier, a pre-amplifier or a single-stage amplifier. The amplifiers may comprise any suitable amplifiers such as, for example, EDFAs. The receivers may be any node in the network suitable for receiving an amplified signal. Thus, for example, the receivers may comprise Node B 104 and/or Node C 106 described above in respect of FIG. 1.

The method may begin in step 202, in which the management node 110 obtains initial gain values applied by the amplifiers 108. The management node 110 may thus calculate initial gain values to be implemented by the amplifiers 108. The management node may determine the initial gain values based on span loss estimates for the spans preceding the amplifiers. Thus, for example, in the example described above with respect to FIG. 1, the initial gain value for Node B 104 may be set to an estimate of the span loss for span L1. The span loss estimate may be determined using any of the methods described above for measuring span loss. Alternatively, the span loss may be determined (e.g. estimated) based on, for example, one or more of: the length of the span, the presence (and/or type) of any nodes along the span (e.g. passive nodes) and a wavelength of a signal transmitted on the span (e.g. the span loss may be specific to one or more wavelengths).

Alternatively, the initial gain values for the amplifiers 108 may be determined based on per-channel output powers for the amplifiers 108.

The initial gain values provide a starting point for the optimisation process. Thus, the skilled person will appreciate that in some embodiments, the initial gain values may be determined in a relatively unsophisticated manner and one or more steps of the foregoing method 200 may be applied iteratively to successively refine the gain values to be applied by the amplifiers 108.

Thus, for example, the initial gain values may be the same for all of the amplifiers 108. Alternatively, the initial gain value for an amplifier may be determined by, for example, the type of amplifier (e.g. EFDA etc.), the function of the amplifier (e.g. whether it operates as a pre-amplifier or booster amplifier etc.) or the type of node containing the amplifier (e.g. whether it is an FOADM, a ROADM, an ILA, etc).

Step 202 may further comprise outputting the initial gain values determined by the management node 110 for implementation by the amplifiers 108. Thus, for example, the management node 110 may send the initial gain values to the amplifiers 108.

Thus, the management node 110 may determine initial gain values to be implemented by the amplifiers 108 and configure the amplifiers 108 with those values.

Alternatively, the initial gain values determined by the management node 110 may instead be used as initial estimate of the gain values being applied by the amplifiers 108. In these embodiments, the initial gain values determined by the management node 110 may be adjusted to improve consistency between the initial gain values and the actual gains being applied by the amplifiers 108. Thus, in step 204 (“saturation adjust”), one or more of the initial gain values may be adjusted based on minimum power values and/or maximum power values for the amplifiers 108. The amplifiers 108 may be associated with a range of output powers, defining minimum output powers, Poutₘᵢₙ, and maximum output powers, Poutₘₐₓ for the amplifiers 108. If an amplifier is configured with a gain that would cause it to output a signal with a power below Poutₘᵢₙ or a power above Poutₘₐₓ, then the amplifier may saturate. Accordingly, although the amplifier may be configured to apply a particular gain value, saturation may cause the amplifier to apply a different gain value.

To account for this, in step 204 the initial gain value for an amplifier may be adjusted if the initial gain value set for the amplifier in step 202 corresponds to gain that would result in the amplifier outputting a signal outside its output power range (e.g. less than Pout,ₘᵢₙ for the amplifier or greater than Poutₘₐₓ for the amplifier). Accordingly, the initial gain values for each amplifier, G, may be adjusted according to:

G=G−Max (0; Pin+G−Poutₘₐₓ)

and

G=G+Max(0; Poutₘᵢₙ−Pin−G),

in which Pin is the optical power input to the amplifier (e.g. the optical power measured by the amplifier at its input). Thus, if the initial gain value, G, for an amplifier with an input power Pin would result in an output power that is greater than the maximum output power for the amplifier, then the gain value is reduced according to the first relation given above. Similarly, if applying an initial gain G to an input signal with power Pin would result in an output power that is less than the minimum output power for the amplifier, then the initial gain value is increased according to the second relation given above.

Thus, in steps 202 and 204, the management node 110 may determine initial gain values for the amplifiers 108 and adjust the initial gain values to obtain a better estimate of the gain being applied by the amplifiers 108. The method may then proceed to step 206.

Alternatively, in step 202, the management node may obtain initial gain values that are already being applied by the amplifiers 108. The management node 110 may thus obtain configuration information or measurements (e.g. output power measurements) for the amplifiers 108 indicating the gains implemented at the amplifiers 108. For example, the management node 110 may receive, from each amplifier 108, an indication of its current gain configuration (e.g. what gain each amplifier is applying). In a further example, the management node 110 may be configured with the gains applied by the amplifier 108. In these embodiments, step 204 may be omitted, and the method may proceed directly from step 202 to step 206.

In step 206, the management node 110 obtains received power measurements for the receivers in the network 100.

The management node 110 may receive the received power measurements directly from the receivers, or the measurements may be received via one or more intermediate nodes in the network 100.

The received power measurements may be sent and/or performed on request by the management node 110. For example, the management node 110 may instruct nodes receiving signals from the amplifiers 108 to perform signal power measurements and send the measurements to the management node 110. Alternatively, the receivers may be configured to report power measurements to the management node 110. The receivers may perform power measurements on all received signals or at predetermined intervals, for example.

In particular examples, one or more of the receivers may be configured to receive a plurality of channels (e.g. on one or more optical fibres). Each channel may have a different wavelength or wavelength band. In these examples, the received power measurements may be specific to particular channels. The management node 110 may thus receive received power measurements per channel (or per wavelength) for a receiver.

In step 208, the management node 110 optionally evaluates one or more exit criteria to determine whether or not to continue with the method. If the exit criteria are satisfied, the management node 208 determines that it is not necessary to refine the gains applied by the amplifiers 108 any further and proceeds to step 210, in which the method ends. The exit criteria are described in more detail below.

If the exit criteria are satisfied, the management node 110 proceeds to step 212, in which the received power measurements and target received power values are input to an optimisation process to determine the gain values (or gain corrections) to be applied by the amplifiers 108.

The target received power values may be the target received power values described above in respect of FIG. 1. Thus, the target received power values specify particular powers at which it is desired or preferable for nodes to receive a signal. A single node may be associated with multiple target received power values that are specific to, for example, each channel received by the node or a type of service or traffic provided on one or more channels received at the node. Alternatively, a node may be associated with a single target received power value (e.g. common to any channels received at the node).

The target received power values may be determined as part of a network design process. The skilled person will appreciate that optical networks, and in particular WDM networks, may be designed according to one or more rules for determining amplifier spacing, optimal channel power, node configuration, amplifier type and/or any other suitable properties of the network. Aspects of the disclosure may relate to a WDM optical network. For example, each channel (optical wavelength) of the WDM network may be separately optimized in the same optimization process. This design process may be used to provide a network configuration that achieves a desired link feasibility (within applicable margins) subject to any cost constraints. An output of the design process may be, for example, details of the links and nodes in the network, including an indication of the expected losses on each link. This information may be used, in turn, to determine target received signal powers for receivers in the network. As these target received signal powers may be determined based on a network configuration designed to optimise the aforementioned network properties (e.g. amplifier spacing, optimal channel power), this can have the further benefit of optimising other network parameters, such as the signal-to-noise ratio achieved at receivers in the network.

According to embodiments of the disclosure, the management node 110 may be preconfigured with the target received power values or the management node 110 may receive the target power values from another node in the network 100 (e.g. a receiver itself). Alternatively, the management node 110 may determine the target received power values based on one or more of the following: a type of the receiver (e.g. whether it is an FOADM, ROADM, ILA, a terminal or endpoint node etc.), a type of node comprising the receiver (e.g. if the receiver is a constituent element in a larger node); a type of service or traffic provided on one or more channels received at the receiver (e.g. 10 G, 25 G, 100 G traffic); a type of modulation applied to signals received at the receiver (e.g. quadrature phase shift keying, QPSK, pulse-amplitude modulation, PAM, etc.). For example, a channel dropped at an FOADM node may be associated with a different target received power to a channel dropped at a terminal (e.g. end) node. In another example, different services or traffic types (e.g. 10 GE, 25 GE, 100 GE etc.) may be set to different power levels and thus may be associated with different target power values. Aspects of the disclosure provide for optimization where channels are dropped (have end points) in different nodes of the network, since the optimization is based on all relevant nodes (e.g. amplifiers, receivers) for each channel.

In particular embodiments, the target received power value for a receiver may be based on one or more other nodes in the network 100. The target received power values may, for example, be determined such that one or more network parameters are optimised.

The network parameters may be any suitable parameters, but in particular may be one or more of: an optical signal-to-noise ratio for one or more receivers in the network; an amplifier tilt (e.g. difference in gain along the respective amplifier's spectrum) for one or more amplifiers in the network; and a launch power (e.g. output channel power) for one or more amplifiers in the network.

In particular examples, the target received power value for a first receiver may be determined based on the sensitivity and overload limits of one or more second receivers downstream of the first receiver. Thus, the target received power value for a channel passing through an intermediate node may be based on an operating range for a downstream receiver (e.g. a receiver that acts as a terminal node for the channel) in the network 100 that is configured to receive the channel. For example, the target received power value for a receiver forming part of an intermediate node for a channel may be based on an operating range of the end-point node for that channel. The target received power values for a particular channel at individual receivers may thus be used to ensure that the power for that channel is optimal throughout the network 100. In this way, the target received power values may be set for individual receivers by considering the overall network architecture. Each receiver can be autonomously and independently set to a different target received power for an overall optimization.

In some examples, the plurality of optical channels (e.g. wavelengths) have different drop points (i.e. end nodes) in the network. For example, an optical channel may be dropped by a FOADM or ROADM, whilst another optical channel is passed through the FOADM or ROADM. The management node is configured to determine the Gain to set at any of the intermediate nodes according to the target receiver power range at different drop points in the network (since there are many channels passing through a node which are dropped at different nodes in the downstream direction). The optimization algorithm cross-correlates the different requirements of the channels, i.e. determines a gain for each amplifier based on the receiver power at a plurality of different end nodes. In some examples, the target received power input into the algorithm may depend on the type of signal or type of node in the network. Given these inputs the algorithm implemented by the management node will calculate the optimum Gain of all amplifiers of the optical link, correlating all the targets for all channels and any other possible given constraints.

The target received power values may be static or they may change over time. In the latter case, the target received power values may be updated when, for example, a new node is added to the network or to account for variations in the network as components age.

As described above, in step 212 the management node 110 inputs the received power measurements and target received power values to an optimisation process to determine updates to gain values applied by the amplifiers 108. Thus, the gain values determined by the optimisation process may be relative to the gains being applied at the amplifiers (e.g. the initial gain values), such that the optimisation process outputs an update to or change in the gain values, Δ̅G̅.

In some embodiments, the management node uses topological information for the network 100 to determine the updates to the gain values in step 212. The topological information may comprise information relating to the types of nodes present in the network 100 and/or the connections of nodes in the network 100. Thus, the topological information may comprise the sequence of nodes present for each end-to-end service in the network 100. For example, for a service going from Node A 102 to Node C 106 in FIG. 1, the sequence may indicate the sequence Node A>L1>Node B>L2>Node C and the topological information may further specify which type of node each of Nodes A-C 102-106 are.

For services operating over a symmetric connection, the sequence may only be specified for a single direction, but assumed to apply in reverse in the opposite direction. Thus, given the sequence above for a service going from Node A 102 to Node C 106, the sequence from Node C 106 to Node A 102 may be assumed to be Node C>L2>Node B>L1>Node A. For services operating over asymmetric connections, a sequence may be specified for each direction.

The optimisation process may be configured with topological information for the optical network 100. Thus, the optimisation process may be specific to the network 100. Alternatively, the optimisation process may suitable for application to a number of networks. Accordingly, topological information for the network 100 may be input to the optimisation process as part of the method 200. For example, the topological information may be input to the optimisation process in step 212 (e.g. each time it is performed).

The method may further comprise providing the optimisation process with traffic information for the network. The traffic information indicates which services or channels the amplifiers 108 operate on. Thus, for example, the traffic information may indicate, for each amplifier 108 in the network, one or more services or channels that it operates on. The traffic information may further indicate the order in which amplifiers 108 in the network 100 operate on a service or channel.

The traffic information may be provided as a traffic matrix, T̅M̅. The traffic matrix may comprise a column for each amplifier 108 and a row for each configured service or channel. Each element of the matrix may thus indicate the presence or absence of a service or channel on a link preceding the amplifier 108 represented in a specific column of the matrix. For example, an element of the traffic matrix may be set to one to indicate that a service is present on the preceding link and set to zero to indicate that a service is absent on a preceding link.

For a network 100 with a traffic matrix, T̅M̅, a change in the gain values applied at amplifiers in the network, Δ̅G̅, causes the received power measured at receivers in the network to change by Δ̅R̅x̅:

Δ̅R̅x̅=R̅x̅_{new}−R̅x̅_{old}=T̅M̅·Δ̅G̅,

in which Rx_{old} are the received powers measured at the receivers at a first time and Rx_{new} are the received powers measured at a second, subsequent time. Using this equation, the received powers that would be achieved given a change in the gain applied at the amplifiers 108 may be expressed as:

R̅x̅_{new}=T̅M̅·Δ̅G̅+R̅x̅_{old}.

In step 212, the optimisation process seeks to determines changes to gain values applied by the amplifier, Δ̅G̅, that would, if applied at the amplifiers 108 in the network 100, cause the receivers in the network to receive signals at the target received power values.

Accordingly, the optimisation process may seek to minimise a difference between R̅x̅_{new} (e.g. the received power that would be measured when new gain values are implemented at the amplifiers) and the target received power values T̅R̅x̅. This difference may be written as:

R̅x̅_{new}−T̅R̅x=T̅M̅·Δ̅G̅+(R̅x̅_{old}−T̅R̅x̅).

Accordingly, the optimisation process may comprise minimising an objective function of the form:

$$Objective function = \frac{1}{2} {‖ {\overline{Rx}}_{n e w} - \overline{TR} x ‖}^{2} = \frac{1}{2} {‖ \overline{TM} * \overline{Δ G} + ( {\overline{Rx}}_{old} - \overline{TRx} ) ‖}^{2} .$$

Since

min (∥Ā·x̅−c̅∥²)=min (x̅^{T}·Ā^{T}·Ā·x̅−c̅^{T}·Ā·x̅),

for any suitable matrices Ā, x̅, and c̅, the minimum of the objective function given above may be expressed as:

$${min}_{x} \frac{1}{2} {\overline{x}}^{T} \cdot \overline{H} \cdot \overline{x} + {\overline{f}}^{T} \cdot \overline{x} ,$$

in which x̅ is the change in gain values ΔG (e.g. the values to be determined by the optimisation process),

H̅=T̅M̅^{T}·T̅M̅,

and

f̅^{T}=(R̅x̅_{old}−T̅R̅x̅)^{T}·T̅M̅.

The optimisation process in step 212 may thus comprise determining the minimum:

$${min}_{x} \frac{1}{2} {\overline{x}}^{T} \cdot \overline{H} \cdot \overline{x} + {\overline{f}}^{T} \cdot \overline{x} .$$

Any suitable minimisation process or algorithm may be used to minimise the objective function. For example, the optimisation process may comprise using a quadratic programming process to determine this minimum. Aspects of the disclosure provide for a single optimization (e.g. by the same minimization process) for a plurality of amplifiers, based on the requirements for the plurality of amplifiers (e.g. minimising difference between target and received power at each receiver).

In the examples above, the objective function is based on the squared Euclidean distance between R̅x̅_{new} and T̅R̅x̅. The squared Euclidean distance may be particularly advantageous as it is minimised using a quadratic programming process, guaranteeing the convexity of the problem, which enables finding a global optimum. However, the skilled person will appreciate that this is just one example of a suitable objective function and there are many other suitable objective functions. In general, any suitable non-linear distance metric may be used as basis for the objective function.

One or more constraints may be applied to the optimisation process. Thus, for example, a linearly constrained quadratic programming process may be used to minimise the objective function subject to one or more constraints.

The one or more constraints may comprise one or more limits on the received signal power measured at the receivers. One or more constraints may thus be placed on the optimisation process so that it does not return values that would result in signals being received at powers that are below a receiver's sensitivity limit and/or above its overload limit, for example. Such a constraint effectively ensures that signals are received at powers that are within the receivers' dynamic range. Accordingly, the constraints may comprise one or more of the following:

R̅x̅_{new}=T̅M̅·Δ̅G̅+R̅x̅_{old}≤R̅o̅−M̅o̅,

R̅x̅_{new}=T̅M̅·Δ̅G̅+R̅x̅_{old}≥R̅s̅+M̅s̅,

in which R̅o̅ and R̅s̅ are the receiver overload and the receiver sensitivity, and M̅o̅ and M̅s̅ are the margins on the receiver overload and receiver sensitivity. The margins may account for quantities such as the confidence (e.g. in the accuracy) of the receiver power measurements. For example, if a receiver power is measured with a confidence of ±2 dB, then the margins may be set to M̅o̅=M̅s̅=2 db.

These constraints may alternatively be expressed as:

Ā·x̅≤b̅

in which x̅=Δ̅G̅ are the values determined by the optimisation process, and

Ā=T̅M̅ and B̅=R̅o̅−M̅o̅−R̅x̅_{old},

for the overload constraint and

Ā=−T̅M̅ and B=R̅x̅_{old}−R̅s̅−M̅s̅

for the sensitivity constraint. These constraints may be rewritten as a single vector by concatenation.

The one or more constraints may, additionally or alternatively, comprise a limit on the gain values to be applied by the receivers. In this context, at least one of the constraints may comprise an upper and or lower limit on the gain values returned by the optimisation process, for example, so as to ensure that the gain values do not vary too much from one iteration to the next. Thus, the constraint may impose an upper limit on Δ̅G̅ (e.g. requiring that Δ̅G̅ is below a predetermined threshold). Such a constraint may be expressed as:

l̅b̅≤x̅≤u̅b̅,

in which x̅=Δ̅G̅, and l̅b̅ and u̅b̅ are lower and upper limits respectively on the change in gain values returned by the optimisation process. In a particular example, −l̅b̅=u̅b̅=4 dB such that the changes in the gain values are limited to ±4 dB, which is the typical error resulting from estimating the span loss using an OSC channel.

The aforementioned constraints may be described as inequality constraints, which impose limits (e.g. upper or lower limits) on one or more parameters in the optimisation process. The one or more constraints may further comprise one or more equality constraints. The equality constraints may be based on the network architecture, for example.

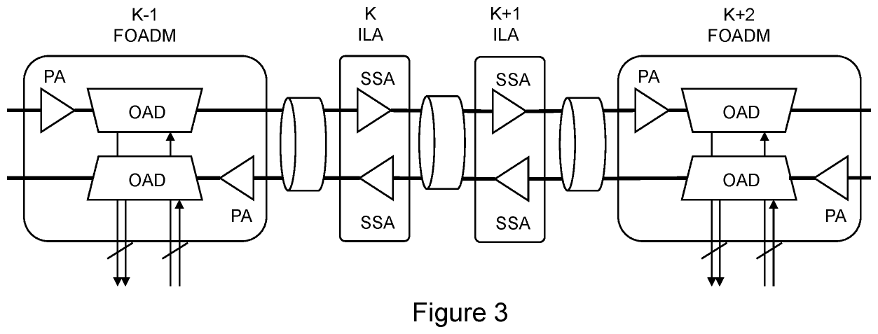

An exemplary equality constraint may be described with reference to FIG. 3, which shows a part of a network comprising first and second FOADMs, labelled nodes K−1 and K+2 respectively, and two ILAs, labelled nodes K and K+1 respectively. The amplifiers in the nodes K, K+1 and K+2 contribute to the received power for any downlink nodes (e.g. for any nodes receiving signals from the K+2 node). In this example, the ILAs are cascaded and no channels are dropped at either of nodes K and K+1. As the ILAs are provided only to amplify signals transmitted on the link (e.g. they do not add or drop channels, or perform any processing other than amplification of received signals), they are not associated with respective target received power values in this example. This means that the optimisation process may be under-constrained with too many degrees of freedom. This may cause the optimisation process to determine gain values that achieve the target received power values for downstream nodes, but provide sub-optimal signal-to-noise ratios at some receivers in the network.

This problem may be addressed by imposing one or more equality constraints on the optimisation process that cause the nodes K, K+1 and K+2 to have the same optical output power. For example, the optimisation process may be subject to the constraints:

Δ̅G̅ₖ₊₁=P̅ₖ−P̅ₖ₊₁

Δ̅G̅ₖ₊₂=P̅ₖ₊₁−P̅ₖ₊₂,

in which Δ̅G̅ₖ₊₁ and Δ̅G̅ₖ₊₂ are the change in gain values determined by the optimization process for the nodes K+1 and K+2 and P̅ₖ, P̅ₖ₊₁ and P̅ₖ₊₂ are received signal power as measured at nodes K, K+1 and K+2 respectively. This constraint may also be expressed as

A̅e̅q̅·x̅=b̅e̅q̅,

in which

$$\overline{Aeq} = ( \begin{matrix}0 & 0 & 0 & 1 & 0 & 0 & 0 & 0 \\ 0 & 0 & 0 & 0 & 1 & 0 & 0 & 0\end{matrix} ) ,$$

wherein the columns containing ones correspond to nodes K+1 and K+2 respectively, and

$$\overline{Beq} = ( \begin{matrix}{P}_{k} - {P}_{k + 1} \\ {P}_{k + 1} - {P}_{k \_ 2}\end{matrix} ) .$$

One or more equality constraints may thus be used to constrain the gain values determined for one or more nodes in the network such that they have a same output power. This can prevent the optimisation process from being under-constrained and reduce the risk that the optimisation process will return gain values that result in a suboptimal signal-to-noise ratio for downstream nodes.

The equality constraint may, additionally or alternatively, comprise a constraint that keeps the gain value to be applied by one or more amplifiers in the network unchanged. This may be relevant if, for example, the gain for a particular amplifier has already been determined accurately (e.g. using the methods described herein). This may be particularly relevant for ILAs, as the gain to be applied may be easier to determine for an ILA than other types of nodes (e.g. FOADMs), as no channels are added or dropped at an ILA. Thus, in example shown in FIG. 3, an alternative constraint may be applied that specifies that the gain implemented at nodes K+1 and K+2 is fixed. This may be expressed as:

Δ̅G̅ₖ₊₁=0

Δ̅G̅ₖ₊₂=0,

or similarly,

$$\overline{Aeq} = ( \begin{matrix}0 & 0 & 0 & 1 & 0 & 0 & 0 & 0 \\ 0 & 0 & 0 & 0 & 1 & 0 & 0 & 0\end{matrix} ) ,$$

$$and$$

$$\overline{Beq} = ( \begin{matrix}0 \\ 0\end{matrix} ) .$$

Thus, one or more equality constraints may be used to fix the gain values for one or more amplifiers in the network (e.g. so they remain constant). The skilled person will appreciate that various combinations of the constraints described herein may be used. For example, one or more equality constraints may be used to fix the gain values for some amplifiers in the network, whilst one or more inequality constraints may be used to limit the gains applied by the other amplifiers in the network such that the received powers for corresponding receivers are below their overload limits.

Accordingly, in step 212 the target received power values and received power measurements are input to an optimisation process to determine gain value updates, AG, for application by the amplifiers 108.

The method may proceed to step 214 in which the output of the optimisation process is evaluated. The skilled person will appreciate that circumstances may arise in which the optimisation process fails to find a solution (e.g. the minimisation process may fail to find a minimum). This may mean, for example, that the constraints applied to the optimisation process are too stringent or that there is a hardware issue in the network 100 (e.g. the losses on the links between nodes are too high). If, in step 214, it is determined that a solution has not been found (e.g. the optimisation process has failed) then the method ends in step 216. In particular examples, an alert or notification of this failure may be generated, thereby indicating to a network operator that an error has occurred.

Alternatively, if, in step 214, it is determined that the optimisation process has successfully returned gain value updates for the amplifiers 108 to be applied to the network 100, then the method proceeds to step 218.

In step 218, the management node 110 outputs gain values to be applied by the amplifiers 108. Thus, the management node 110 may, for example, send the change in gain value, AG, to the amplifiers 108 for implementation (e.g. for the amplifiers to apply a gain value AG+G, in which G are the gain values currently being applied by the respective amplifiers). Alternatively, the management node 110 may set the gain values to be applied by the amplifiers equal to the sum of the gain value updates plus the initial gain values (e.g. as determined in steps 202 or 204). The management node 110 may thus send AG+Gᵢ to the amplifiers 108, in which Gᵢ are the initial gain values obtained in step 202 (or the initial gain values as adjusted in step 204).

In either case, the management node 110 may send the gain values (e.g. Δ̅G̅ or Δ̅G̅+G̅ᵢ) to the amplifiers 108 directly or indirectly (e.g. via one or more intermediate nodes in the network).

As noted above, the method 200 may be applied iteratively, such that the gain values implemented by the amplifiers 108 are successively refined with each iteration of the method. Thus, the method 200 may proceed from step 218 to step 204, in which saturation adjustment is performed on the gain values output by the management node 110 in step 218.

In particular embodiments, when setting the gain values in step 218, the management node may additionally instruct one or more receivers in the network to report received power measurement values (e.g. for signals amplified using the gain values determined in step 212). Thus, the management node may both instruct amplifiers to implement the new gain values and request corresponding received power measurements from the receivers to be used in step 206 in the next iteration of the method 200.

The process 200 may thus be implemented iteratively to successively improve gain values returned by the optimisation process. As described above in respect of step 208, the management node 110 may evaluate one or more exit criteria to determine whether or not to repeat the optimisation process. The exit criteria are described here in more detail.

The exit criteria may relate to one or more operating ranges for the receivers. The exit criteria may thus relate to a minimum received power threshold (sensitivity) and a maximum received power threshold (overload) for the receivers. For example, if the received power measurements for each of the amplifiers is within their respective operating range, then the management node 110 may end the method in step 210.

The exit criteria may, additionally or alternatively, relate to a minimum signal-to-noise ratio for the receivers. The management node may receive signal-to-noise ratio measurements from the receivers and compare the signal-to-noise ratio measurements for the amplifiers to one or more minimum signal-to-noise ratio values. If the measurements exceed the minimum signal-to-noise ratio values, then the method may end in step 210.

The exit criteria may be based on a difference between gain values determined in successive iterations of the method 200. For example, if the change in gain values, AG, is below a minimum threshold value, then the management node 110 may terminate the method in step 210. This provides a measure of whether or not the gains determined by the method have converged.

The method 200 may be implemented at regular intervals, such as periodically throughout the lifetime of a network. Alternatively, the method 200 may be implemented in response to a trigger in the network, such as a received power measured at a receiver exceeding a threshold or the addition, reconfiguration or removal of a node in the network 100.

Embodiments of the disclosure thus provide a method 200 for optimising gain values to be implemented by amplifiers 108 in an optical network 100. By determining gain values based on initial gain values, received power measurements and target received power values for multiple amplifiers 108 and receivers in the network 100, the method 200 reduces the risk of receivers being overloaded or receiving signals below their sensitivity limits. This, in turn, reduces the risk of data being lost or corrupted in the network 100.

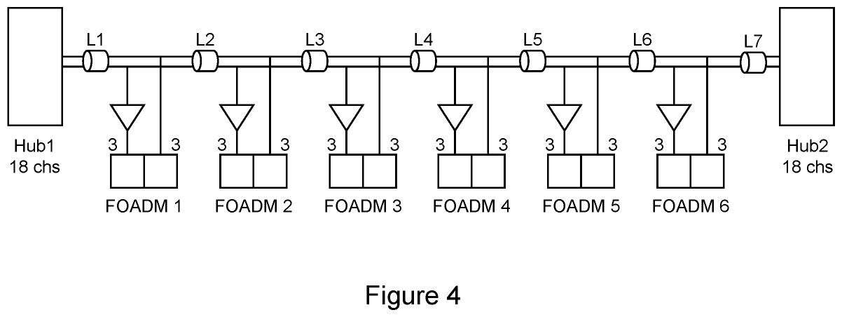

FIG. 4 shows an example of an optical network according to embodiments of the disclosure.

The network illustrated in FIG. 4 comprises a WDM link between two terminals, Hub 1 and Hub 2, in which the link carries 36 100 GE services. There are 7 spans and six type-two FOADMs between the two terminals. The network is configured in a protected horse-shoe topology.

At the Hub1, 18 channels are launched at the following wavelength numbers: 1, 2, 3, 7, 8, 9, 13, 14, 15, 19, 20, 21, 25, 26, 27, 31, 32, 33.

At each FOADM node, 3 channels from Hub1 are dropped and 3 other channels at different wavelengths are added to be sent to Hub2 which is configured to receive the wavelengths: 4, 5, 6, 10, 11, 12, 16, 17, 18, 22, 23, 24, 28, 29, 30, 34, 35, 36.

The traffic matrix for the network may be expressed as follows:

$$[ \begin{matrix}1 & 0 & 0 & 0 & 0 & 0 & 0 \\ 1 & 0 & 0 & 0 & 0 & 0 & 0 \\ 1 & 0 & 0 & 0 & 0 & 0 & 0 \\ 1 & 1 & 0 & 0 & 0 & 0 & 0 \\ 1 & 1 & 0 & 0 & 0 & 0 & 0 \\ 1 & 1 & 0 & 0 & 0 & 0 & 0 \\ 1 & 1 & 1 & 0 & 0 & 0 & 0 \\ 1 & 1 & 1 & 0 & 0 & 0 & 0 \\ 1 & 1 & 1 & 0 & 0 & 0 & 0 \\ 1 & 1 & 1 & 1 & 0 & 0 & 0 \\ 1 & 1 & 1 & 1 & 0 & 0 & 0 \\ 1 & 1 & 1 & 1 & 0 & 0 & 0 \\ 1 & 1 & 1 & 1 & 1 & 0 & 0 \\ 1 & 1 & 1 & 1 & 1 & 0 & 0 \\ 1 & 1 & 1 & 1 & 1 & 0 & 0 \\ 1 & 1 & 1 & 1 & 1 & 1 & 0 \\ 1 & 1 & 1 & 1 & 1 & 1 & 0 \\ 1 & 1 & 1 & 1 & 1 & 1 & 0 \\ 0 & 1 & 1 & 1 & 1 & 1 & 1 \\ 0 & 1 & 1 & 1 & 1 & 1 & 1 \\ 0 & 1 & 1 & 1 & 1 & 1 & 1 \\ 0 & 0 & 1 & 1 & 1 & 1 & 1 \\ 0 & 0 & 1 & 1 & 1 & 1 & 1 \\ 0 & 0 & 1 & 1 & 1 & 1 & 1 \\ 0 & 0 & 0 & 1 & 1 & 1 & 1 \\ 0 & 0 & 0 & 1 & 1 & 1 & 1 \\ 0 & 0 & 0 & 1 & 1 & 1 & 1 \\ 0 & 0 & 0 & 0 & 1 & 1 & 1 \\ 0 & 0 & 0 & 0 & 1 & 1 & 1 \\ 0 & 0 & 0 & 0 & 1 & 1 & 1 \\ 0 & 0 & 0 & 0 & 0 & 1 & 1 \\ 0 & 0 & 0 & 0 & 0 & 1 & 1 \\ 0 & 0 & 0 & 0 & 0 & 1 & 1 \\ 0 & 0 & 0 & 0 & 0 & 0 & 1 \\ 0 & 0 & 0 & 0 & 0 & 0 & 1 \\ 0 & 0 & 0 & 0 & 0 & 0 & 1\end{matrix} ]$$

in which each of the 36 rows corresponds to a service on the link and each of the 7 columns corresponds to one of the amplified FOADMs or the terminal Hub 2. Thus, the value at index (i,j) in the matrix indicates that the ith channel or service is amplified at the jth node in the network.

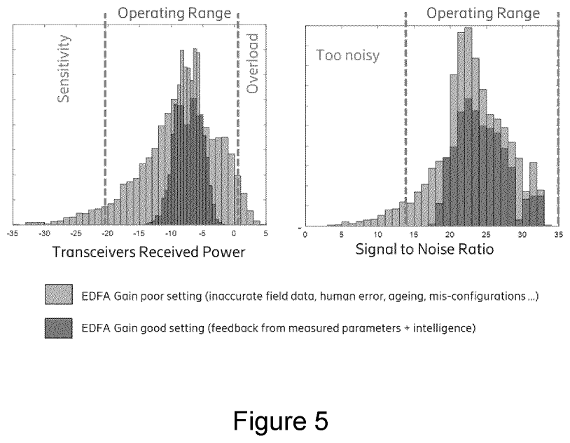

FIG. 5 shows received power measurements and signal-to-noise ratio measurements for receivers in a simulation of the network shown in FIG. 4, in which amplifier gains are either determined using existing approaches for determining amplifier gains (the first gain settings; “EDFA Gain poor setting”) or according to embodiments of the present disclosure (the second gain settings; “EDFA Gain good setting”).

In particular, according to the first gain settings, the gain for each amplifier in the network was set to the span loss on link preceding the amplifier, subject to an error of up to ±4 dB. This is consistent with the typical errors in span loss estimates obtained using an OSC, for example.

In contrast, the second gain settings were determined using an example of the disclosure (e.g. the method 200 described above in respect of FIG. 2), using a target received power value of T̅R̅x̅=−7 dBm for FOADM nodes and a target received power value of T̅R̅x̅=—8.4 dBm for the terminal node, Hub 2. These values were determined based on the network design. The 100 GE transceivers in the network nodes (e.g. in the FOADMs and Hub 2) have an overload limit of R̅o̅=1 dBm and a sensitivity of R̅s̅=−20 dBm, with the margin of M̅o̅=M̅s̅=2 dB.

The resulting distributions of received signal powers and signal-to-noise ratios for the receivers are shown in FIG. 5. As shown in FIG. 5, the first gain settings result in a significant number of cases in which key optical parameters, the received signal power and signal-to-noise ratio, are outside of the receivers' operating range. This makes the link unfeasible, as it risks data loss or data corruption occurring on the link.

In contrast, the second gain settings, which were determined according to embodiments of the present disclosure, cause the received signal power and signal-to-noise ratio to be centred in and contained in the receivers' operating range. Accordingly, there is a decreased loss of data loss or corruption when embodiments of the present disclosure are implemented.

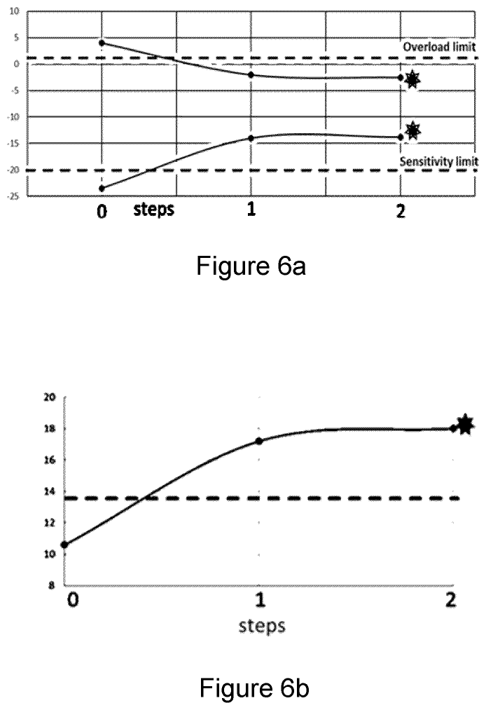

FIG. 6a shows the maximum received power values (upper line) and minimum received power values (lower line) achieved in the simulation of the network shown in FIG. 4 when using gain values determined after 0, 1 and 2 iterations of the method 200 described above.

Similarly, FIG. 6b shows the signal-to-noise measured at the receivers in the simulated network after 0, 1 and 2 iterations of the method 200. In both FIGS. 6a and 6b, the optimal values (e.g. that would be obtained if gain values at amplifiers were accurately set to the span loss on the preceding link) are indicated by a star. As shown, the method 200 provides gain values that result in the received signal powers being between the receivers' overload limit and sensitivity limit after only one iteration. Similarly, the signal-to-noise ratio for the receivers is above a minimum noise threshold after only a single iteration. The received power values and signal-to-noise ratios approach the optimal values after only two iterations, which means that the method quickly and efficiently converges on the optimal gain values for the network.

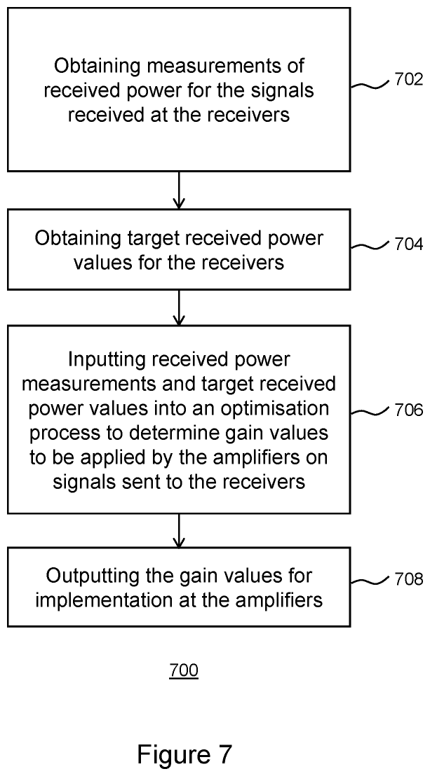

FIG. 7 is a flowchart of a method 700 performed by a management node in an optical network according to embodiments of the disclosure. The optical network may be, for example, the optical network 100 described above in respect of FIG. 1. The management node may be the management node 110 described above in respect of FIG. 1, for example.

The optical network 100 comprises a plurality of amplifiers and receivers. The amplifiers may be the amplifiers 108 described above in respect of FIG. 1. The amplifiers may comprise one or more booster amplifiers configured to amplify signals for transmission to corresponding receivers, for example.

The method begins in step 702, in which the management node 110 obtains measurements of received power for the signals received at the receivers.

Thus, for example, the management node may, in step 702, obtain received power measurements as described above in respect of step 206 in the method 200 shown in FIG. 2.

In step 704, the management node 110 obtains target received power values for the receivers. The management node 110 may be configured with the target received power values. Alternatively, the management node 110 may receive the target received power values from another node in the network 100 such as, for example, the receivers themselves.

In step 708, the management node 110 inputs the received power measurements and target received power values into an optimisation process to determine gain values to be applied by the amplifiers 108 on signals sent to the receivers. Thus, the management node 110 may perform the optimisation process as described in respect of step 212 in FIG. 2 above, for example.

The gain values may comprise absolute gain values for implementation by the amplifiers or they may comprise updates or changes to the gain values to be applied by the amplifiers (e.g. the difference with respect to gain values previously implemented by the amplifiers).

The management node 110 outputs the determined gain values for implementation at the amplifiers 108 in step 710. The management node 110 may thus send the gain values to the amplifiers 108, thereby configuring the amplifiers 108 to apply gains corresponding to the gain values on signals amplified at the amplifiers 108.

The method 700 may be performed iteratively such that the received power measurements obtained in step 702 may correspond to measurements performed by receivers on signals amplified according to gain values determined by the optimisation process. By performing the method 700 iteratively, the gain values obtained by the optimisation process may be successively refined to provide improved network performance. Moreover, performing the method 700 iteratively means that the gain values may be adapted according to changes in the network, such as deterioration due to hardware changes.

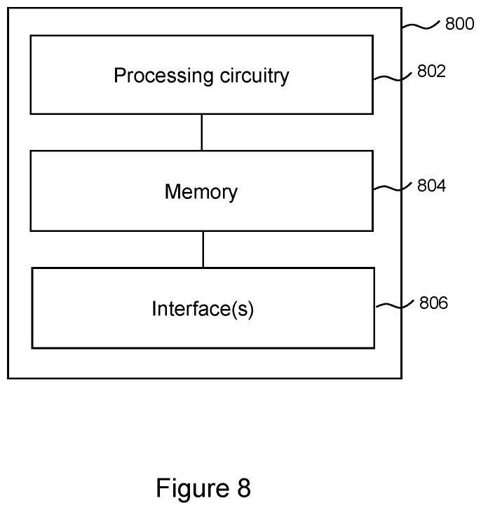

FIG. 8 is a schematic diagram of an apparatus 800 operable to implement a management node for an optical network according to embodiments of the disclosure. The optical network comprises a plurality of receivers and a plurality of amplifiers. The apparatus 800 may implement, for example, the management node 110 described above in respect of FIG. 1. The apparatus 800 may be operable to carry out the example methods 200 and 700 described with reference to FIGS. 2 and 7 respectively, and possibly any other processes or methods disclosed herein. It is also to be understood that the methods of FIGS. 2 and 7 may not necessarily be carried out solely by the apparatus 800. At least some operations of the methods can be performed by one or more other entities.

The apparatus 800 comprises processing circuitry 802 (such as one or more processors, digital signal processors, general purpose processing units, etc), a machine-readable medium 804 (e.g., memory such as read-only memory (ROM), random-access memory, cache memory, flash memory devices, optical storage devices, etc) and one or more interfaces 806.

In one embodiment, the machine-readable medium 804 stores instructions which, when executed by the processing circuitry 802, cause the apparatus 800 to obtain measurements of received power for the signals received at the receivers. The apparatus 800 is further caused to obtain target received power values for the receivers, and input the received power measurements and target received power values into an optimisation process to determine gain values to be applied by the amplifiers on signals sent to the receivers. The apparatus 800 is further caused to output the gain values for implementation at the amplifiers.

In other embodiments, the processing circuitry 802 may be configured to directly perform the method, or to cause the apparatus 800 to perform the method, without executing instructions stored in the non-transitory machine-readable medium 804, e.g., through suitably configured dedicated circuitry.

The one or more interfaces 806 may comprise hardware and/or software suitable for communicating with other nodes of the communication network using any suitable communication medium. For example, the interfaces 806 may comprise one or more wired interfaces, using optical or electrical transmission media. Such interfaces may therefore utilize optical or electrical transmitters and receivers, as well as the necessary software to encode and decode signals transmitted via the interface. In a further example, the interfaces 806 may comprise one or more wireless interfaces. Such interfaces may therefore utilize one or more antennas, baseband circuitry, etc. The components are illustrated coupled together in series; however, those skilled in the art will appreciate that the components may be coupled together in any suitable manner (e.g., via a system bus or suchlike).

In further embodiments of the disclosure, the apparatus 800 may comprise power circuitry (not illustrated). The power circuitry may comprise, or be coupled to, power management circuitry and is configured to supply the components of apparatus 800 with power for performing the functionality described herein. Power circuitry may receive power from a power source. The power source and/or power circuitry may be configured to provide power to the various components of apparatus 800 in a form suitable for the respective components (e.g., at a voltage and current level needed for each respective component). The power source may either be included in, or external to, the power circuitry and/or the apparatus 800. For example, the apparatus 800 may be connectable to an external power source (e.g., an electricity outlet) via an input circuitry or interface such as an electrical cable, whereby the external power source supplies power to the power circuitry. As a further example, the power source may comprise a source of power in the form of a battery or battery pack which is connected to, or integrated in, the power circuitry. The battery may provide backup power should the external power source fail. Other types of power sources, such as photovoltaic devices, may also be used.

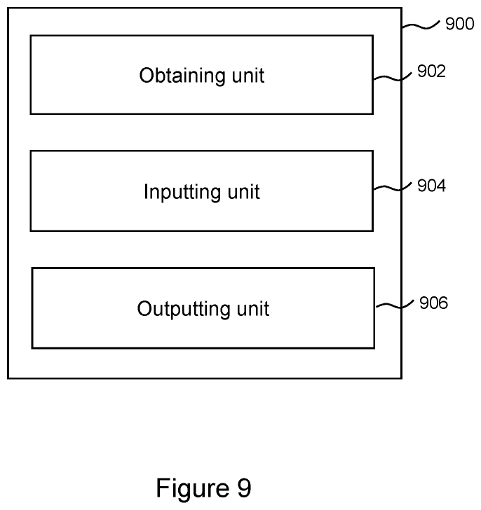

FIG. 9 is a schematic diagram of an apparatus 900 operable to implement a management node for an optical network according to embodiments of the disclosure. The optical network comprises a plurality of receivers and a plurality of amplifiers. The apparatus 900 may implement, for example, the management node 110 described above in respect of FIG. 1. The apparatus 900 may be operable to carry out the example methods 200 and 700 described with reference to FIGS. 2 and 7 respectively, and possibly any other processes or methods disclosed herein. It is also to be understood that the methods of FIGS. 2 and 7 may not necessarily be carried out solely by the apparatus 900. At least some operations of the method can be performed by one or more other entities.

The apparatus 900 comprises an obtaining unit 902, which is configured to obtain measurements of received power for the signals received at the receivers. The obtaining unit is further configured to obtain target received power values for the receivers. The apparatus 900 further comprises an inputting unit 904, which is configured to input the received power measurements and target received power values into an optimisation process to determine gain values to be applied by the amplifiers on signals sent to the receivers. The apparatus 900 further comprises an outputting unit 906, which is configured to output the gain values for implementation at the amplifiers.

Thus, for example, the obtaining unit 902, the inputting unit 904 and the outputting unit 906 may be configured to perform steps 702 and 704, 706 and 708 (described above in respect of FIG. 7) respectively.

The apparatus 900 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause obtaining unit 902, inputting unit 906 and outputting unit 906, and any other suitable units of apparatus 900 to perform corresponding functions according one or more embodiments of the present disclosure.

The apparatus 900 may additionally comprise power-supply circuitry (not illustrated) configured to supply the apparatus 900 with power.

Aspects of the disclosure may further comprise a system comprising the management node and a plurality of apparatus (optical nodes) comprising the amplifiers. In some aspects, the management node may comprise one node or a plurality of separate nodes, e.g. the functions described for the management node may be implemented by a plurality of nodes.

It should be noted that the above-mentioned examples illustrate rather than limit the invention, and that those skilled in the art will be able to design many alternative examples without departing from the scope of the appended statements. The word “comprising” does not exclude the presence of elements or steps other than those listed in a claim, “a” or “an” does not exclude a plurality, and a single processor or other unit may fulfil the functions of several units recited in the statements below. Where the terms, “first”, “second” etc. are used they are to be understood merely as labels for the convenient identification of a particular feature. In particular, they are not to be interpreted as describing the first or the second feature of a plurality of such features (i.e. the first or second of such features to occur in time or space) unless explicitly stated otherwise. Steps in the methods disclosed herein may be carried out in any order unless expressly otherwise stated. Any reference signs in the statements shall not be construed so as to limit their scope.

1-30. (canceled)

31. A method performed by a management node for an optical network, the optical network comprising a plurality of receivers and a plurality of amplifiers, the method comprising:
obtaining measurements of received power for signals received at the receivers;
obtaining target received power values for the receivers;
inputting the received power measurements and target received power values into an optimization process to determine gain values to be applied by the amplifiers on signals sent to the receivers; and
outputting the gain values for implementation at the amplifiers.

32. The method of claim 31, further comprising inputting traffic information for the optical network to the optimization process, the traffic information indicating which channels in the optical network are amplified by respective amplifiers.

33. The method of claim 31, wherein the optimization process comprises a minimization process that minimizes a difference between the received power measurements and the target received power values.

34. The method of claim 31, wherein:
the target received power values for the receivers comprise one or more target received power values for each receiver; and
the received power measurements for the receivers comprise one or more received power measurements for each receiver.

35. The method of claim 34, wherein, for a respective receiver:
the target received power values for the receiver comprise a target received power value for each channel received at the receiver; and
the received power measurements for the receiver comprise a received power measurement for each channel received at the receiver.

36. The method of claim 31, wherein obtaining the target received power values for the receivers comprises receiving target received power values for the receivers that optimize one or more network parameters.

37. The method of claim 36, wherein the network parameters comprise at least one of the following:
an optical signal-to-noise ratio for one or more receivers in the network;
an amplifier tilt;
a bit error rate; and
a launch power for one or more amplifiers in the network.

38. The method of claim 31, wherein obtaining the target received power values for the receivers comprises determining, for a respective receiver, one or more target received power values based on one or more of the following:
a receiver type;
a type of node comprising the receiver; and
a type of service provided on one or more channels received at the receiver.

39. The method of claim 31, wherein the optimization process is configured with topological information for the optical network such that the optimization process is specific to the optical network.

40. The method of claim 31, further comprising inputting topological information for the optical network into the optimization process to determine the gain values, and/or, wherein the receivers are at a plurality of different nodes of the optical network.

41. The method of claim 31, further comprising constraining the optimization process using one or more constraints determined based on at least one of the following:
receiver overload values for the receivers;
receiver sensitivity values for the receivers;
confidence values for the received power measurements; and
a maximum change in the gain values to be applied by the amplifiers.

42. The method of claim 31, comprising:
repeating said method iteratively until one or more criteria are satisfied.

43. The method of claim 42, wherein the one or more criteria comprise at least one of the following:
a difference between first gain values implemented at the amplifiers after a first iteration of the method and second gain values implemented at the amplifiers after a second iteration of the method being less than a predetermined threshold value;
the received power measurements for the receivers being within a predetermined range; and
a threshold number of iterations of the method being reached.

44. The method of claim 31, further comprising:
determining initial gain values to be applied by the amplifiers based on estimates of span loss for links between the amplifiers and the respective receivers;
outputting the initial gain values for implementation at the amplifiers;
initiating measurement of received power for the receivers on signals amplified by the amplifiers according to the initial gain values; and
receiving the received power measurements for the receivers. (New) An apparatus configured to perform the method of claim 31.

46. A management node for an optical network, wherein the optical network comprises a plurality of receivers and a plurality of amplifiers, and the management node comprises processing circuitry and a machine-readable medium which, when executed by the processing circuitry, causes the management node to:
obtain measurements of received power for the signals received at the receivers;
obtain target received power values for the receivers;
input the received power measurements and target received power values into an optimization process to determine gain values to be applied by the amplifiers on signals sent to the receivers; and
output the gain values for implementation at the amplifiers.

47. The management node of claim 48, wherein the processing circuitry further causes the management node to input traffic information for the optical network to the optimization process, the traffic information indicating which channels in the optical network are amplified by respective amplifiers.

48. The management node of claim 46, wherein the optimization process comprises a minimization process that minimizes a difference between the received power measurements and the target received power values.

49. The management node of claim 46, wherein:
the target received power values for the receivers comprise one or more target received power values for each receiver; and
the received power measurements for the receivers comprise one or more received power measurements for each receiver.

50. The management node of claim 46, wherein, for a respective receiver:
the target received power values for the receiver comprise a target received power value for each channel received at the receiver; and
the received power measurements for the receiver comprise a received power measurement for each channel received at the receiver.
